(19) United States
(12) Patent Application Publication
(10) Pub. No.: US 2009/0001109 A1
(43) Pub. Date: Jan. 1, 2009

(54) Trailer hitch tire carrier gate

(76) Inventor: Paul T. Wilkins, Santa Ana, CA (US)

Correspondence Address: STETINA BRUNDA GARRED & BRUCKER, 75 ENTERPRISE, SUITE 250, ALISO VIEJO, CA, 92656, US

(21) Appl. No.: 11/821,943

(22) Filed: Jun. 26, 2007

(51) Int. Cl. B62D 43/02; B60D 1/00

(52) U.S. Cl. 224/42.21; 224/519

(57) ABSTRACT

A tire carrier is provided wherein a tire mount is fixed to a rotating member opposite from a pivot axis such that the tire is cleared away from a rear of the vehicle when the tire carrier is traversed to an access position. Additionally, the tire carrier is mountable in the rear hitch receiver with an expandable tongue for reducing shaking of the tire carrier when the vehicle is being driven upon uneven terrain.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a tire carrier.

Modern vehicles are equipped with a spare tire in the event that one of the four main tires is punctured or somehow damaged. The damaged or punctured tired may be replaced with the spare tire. Unfortunately, due to the limited space within the vehicle, the spare tire have been mounted to the exterior side of the vehicle body. For example, a spare tired rack has been mounted to the vehicle body itself at the rear of the vehicle. The tire carrier rack can be opened or closed to swing the tire away from the vehicle to allow access to the rear side of the vehicle.

Unfortunately, due to certain limitations of such tire carrier racks, there is a need in the art for an improved tire carrier.

### BRIEF SUMMARY

The tire carrier discussed herein addresses the problems discussed above, discussed below and those that are known in the art.

The tire carrier may have a first elongate member and a second elongate member. The second elongate member may be fixedly attached to the vehicle. The first elongate member may be rotatably attached to the second elongate member. The first elongate member is traversable between an access position and a driving position. In the driving position, a tire mounted to the tire carrier is offset from a midpoint of the vehicle. Additionally, the pivot axis, about which the first elongate member rotates, is positioned on an opposite side from the tire. When the tire carrier is traversed to an access position, the tire traverses along a wide arc about the pivot axis. As such, in the access position, the tire is cleared away from the rear of the vehicle. The driver, passenger or other personnel may have clear access to the rear of the vehicle when the tire carrier is traversed to the access position. Also, the tire carrier clears the tail light of the vehicle. After the driver or passenger has accessed the rear of the vehicle, the tire carrier may then be traversed back to the driving position in which the tire is securely attached and closely adjacent to the rear of the vehicle.

The tire carrier may also reduce vibration or shaking of the tire and tire carrier when the vehicle is being driven upon uneven terrain. In particular, the tire carrier may be insertable into a rear hitch receiver of the vehicle. The tire carrier may have an expandable tongue traversable between a release position and an expanded position. In the release position, the expandable tongue may be inserted or removed from the rear hitch receiver. In the expanded position, the expandable tongue expands out to have a snug fit with the inner surface of the rear hitch receiver. The snug fit between the expandable tongue and the rear hitch receiver minimizes or mitigates shaking of the tire carrier when the vehicle is being driven upon uneven terrain.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a rear view of a vehicle with a tire carrier mounted to a rear hitch receiver and in a driving position, the tire carrier has a secondary rear hitch receiver;

FIG. 2 is a rear view of the tire carrier in an access position;

FIG. 3 is an enlarged view of a joint between a first elongate member and a second elongate member of the tire carrier;

FIG. 4 is an enlarged view of a latch pin joint for securing the first elongate member to the second elongate member of the tire carrier;

FIG. 5 is a rear perspective view of the tire carrier;

FIG. 6 is an exploded side view of an expandable tongue of the tire carrier and the rear hitch receiver sized and configured to receive the expandable tongue;

FIG. 7 is a cross sectional view of the expandable tongue and the rear hitch receiver; and

FIG. 8 is a cross sectional view of the expandable tongue and the rear hitch receiver having a reversed orientation compared to the expandable tongue and rear hitch receiver shown in FIG. 7.

### DETAILED DESCRIPTION

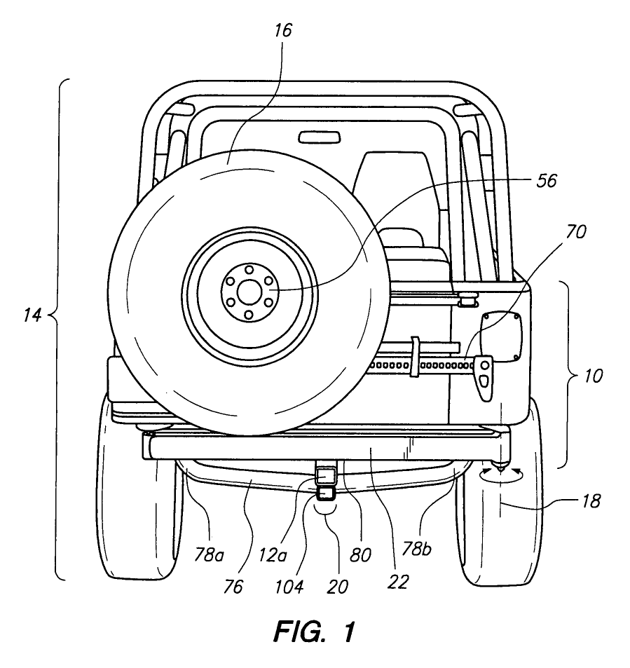

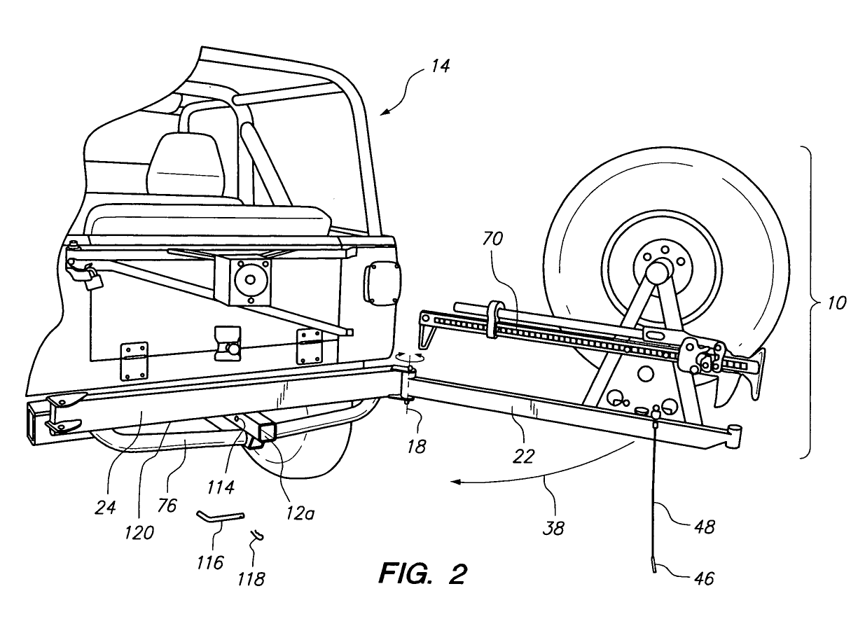

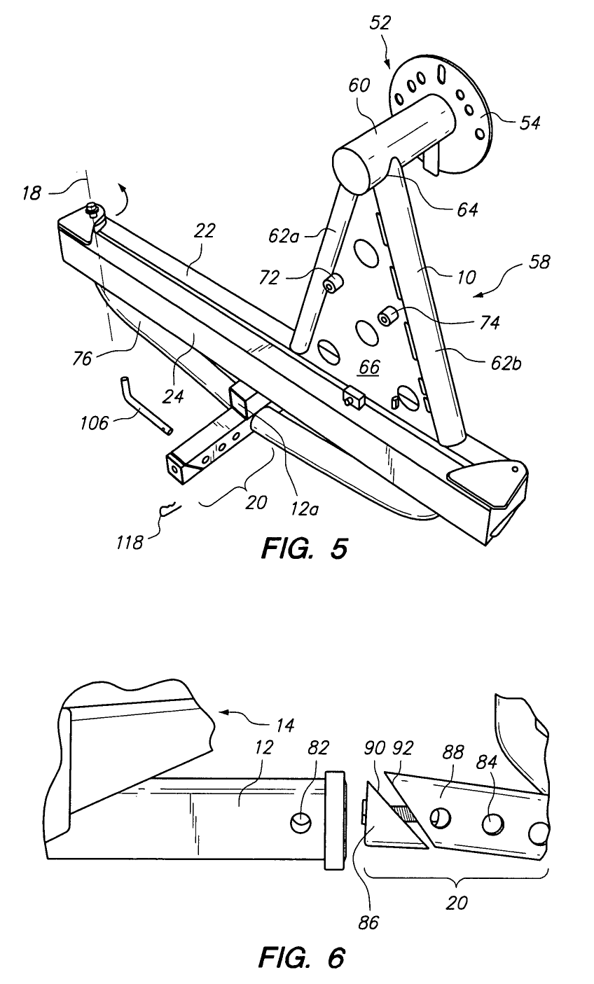

The drawings illustrate a tire carrier 10 (see FIG. 1) mountable to a rear hitch receiver 12 (see FIG. 6) of a vehicle 14. The tire carrier 10 may be traversable between a driving position (see FIG. 1) and an access position (see FIG. 2). The tire carrier 10 may be traversed to the driving position when the vehicle 14 is being driven. Also, the tire carrier 10 may be traversed to the access position to access the rear of the vehicle 14. Moreover, the tire 16 may be mounted opposite from a pivot axis 18 such that the tire 16 clears the rear of the vehicle 14 and the tail light when the tire carrier 10 is traversed to the access position (see FIG. 2).

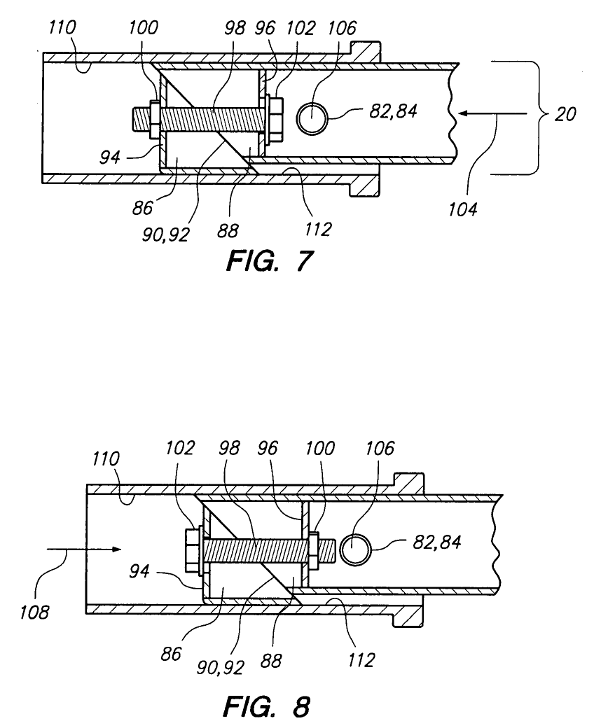

The tire carrier 10 may also have an expandable tongue 20 insertable into the rear hitch receiver 12 of the vehicle 14, as shown in FIG. 6. The expandable tongue 20, once inside the rear hitch receiver 12, may expand within the rear hitch receiver 12 to mitigate or reduce shaking of the tire carrier 10 while the vehicle 14 is being driven on uneven terrain, as shown in FIGS. 7 and 8.

The tire carrier 10 may be traversed between the driving position (see FIG. 1) and the access position (see FIG. 2). In the access position, the tire carrier 10 is secured to the vehicle 14 such that the tire carrier 10 and the tire 16 does not shake while the vehicle 14 is being driven. For example, the vehicle 14 may be driven on a local street, highway, dirt road or other uneven terrain. Nonetheless, due to the secure attachment of the tire carrier 10 and tire 16 to the vehicle 14, the tire carrier 10 and tire 16 does not shake excessively while the vehicle 14 is being driven.

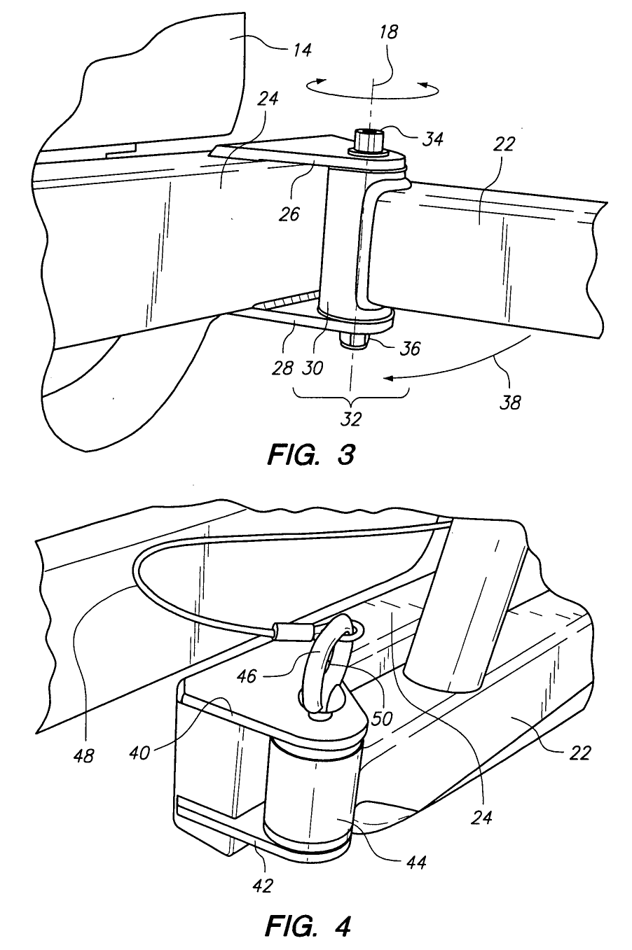

Referring now to FIG. 2, the tire carrier 10 may comprise a first elongate member 22 and a second elongate member 24. The second elongate member 24 may be stationary with respect to the vehicle 14. In contrast, the first elongate member 22 may rotate with respect to the second elongate member 24 about the pivot axis 18. The second elongate member 24 may have an upper plate 26 and a lower plate 28, as shown in FIG. 3. The upper and lower plates 26, 28 extend out reawardly and horizontally from the second elongate member 24. An aperture may be formed through the upper and lower plates 26, 28. The upper and lower plates 26, 28 may be attached to a right distal end portion of the second elongate member 24. Also, a tubular member 30 may be attached to a right distal end portion of the first elongate member 22. The tubular member 30 may be sized and configured so as to be interposable between the upper and lower plates 26, 28. The tubular member 30 may additionally have a through hole which is aligned or alignable to the apertures formed in the upper and lower plates 26, 28. The through hole of the tubular member 30 may additionally have recesses for upper and lower bearings to provide smooth rotation of the first elongate member 22 about the pivot axis 18. To complete assembly of the rotating joint 32 between the first and second elongate members 22, 24, a bolt 34 may be inserted through the aperture of the upper plate 26, the through hole of the tubular member 30 and the aperture of the lower plate 28. A nut 36 may be attached to the threaded end of the bolt 34 protruding out a bottom side of the lower plate 28. The nut 36 is tightened onto the bolt 34. This construction permits the second elongate member 24 to pivot about the pivot axis 18 between the access position and the driving position.

To traverse the tire carrier 10 to the driving position, the second elongate member 24 is rotated in the direction of the arrow 38 shown in FIGS. 2 and 3. The second elongate member 24 may be rotated until a left distal end portion of the first elongate member 22 is aligned to a left distal end portion of the second elongate member 24, as shown in FIG. 4. In particular, the second elongate member 24 may additionally have upper and lower plates 40, 42. The upper and lower plates 40, 42 extend rearwardly and horizontally from the left distal end portion of the second elongate member 24. Similar to the upper and lower plates 26, 28, the upper and lower plates 40, 42 may also have apertures therethrough. These apertures are alignable to a through hole of a tubular member 44 attached to a left distal end of the first elongate member 22. The apertures formed in the upper and lower plates 40, 42 and the through hole of the tubular member 44 may be sized and configured to snuggly receive a pin 46 which is removably insertable therefrom. The pin 46 may be tethered to the tire carrier 10 or first elongate member 22 via a cable 48, as shown in FIG. 2. To secure the tire carrier 10 in the driving position, the pin 46 is inserted through the apertures of the upper and lower plates 40, 42 as well as the through hole of the tubular member 44. While the vehicle 14 is being driven, the pin 46 remains within the apertures of the upper and lower plates 40, 42 and the through hole of the tubular member 44. In this manner, the tire 16 (see FIG. 1) and the first elongate member 22 do not shake while the vehicle 14 is being driven on uneven terrain (paved street, dirt road, etc.). The pin 46 may have an eyelet 50 through which the user may insert his/her finger to assist the user in either removing or inserting the pin 46 to release or lock the tire carrier 10 to the driving position.

As shown in FIG. 5, the tire carrier 10 may have a tire mount 52. The tire mount 52 may be a circular flange 54 having a plurality of apertures. The plurality of apertures may be sized, configured and positioned so as to be alignable to mounting holes of a tire rim 56 (see FIG. 1). To mount the tire 16 to the tire carrier 10, the mounting holes of the tire rim 56 may be aligned to the apertures formed in the flange 54. Bolts may be inserted through aligned apertures of the flange 54 and mounting holes of the tire rim 56. Nuts may be secured to the bolts and tightened thereon to firmly secure the tire 16 to the flange 54.

The flange 54 may be securely fixed or attached to the first elongate member 22 via an A-frame 58 and an extension 60. The A-frame 58 may comprise two tubes 62a, b which extend upwardly from the first elongate member 22 and meet at an apex 64. The extension 60 may also be attached to the tube 62a, b at the apex 64. The extension 60 may extend rearwardly and horizontally away from the first elongate member 22. In this manner, the tire 16 is cleared away from the vehicle 14, the A-frame 58 and the first elongate member 22 when the tire 16 is attached to the flange 54. The A-frame 58 may also comprise a web 66 welded or attached to an inner periphery of the A-frame 58 along the tubes 62a, b and the first elongate member 22. The A-frame 58 may be welded or attached to an upper surface of the first elongate member 22 in a vertical orientation. The A-frame 58 may additionally be attached to the first elongate member 22 on opposing sides with respect to the pivot axis 18 (see FIG. 5). Accordingly, the center of gravity of the tire 16 is opposite from the pivot axis 18 (see FIG. 1). Since the A-frame 58 is positioned on an opposite side with respect to the pivot axis 18, the user is provided maximum space or room at the rear of the vehicle 14 when the tire carrier 10 is traversed to the access position (see FIG. 2).

The tire carrier 10 may additionally carry a jack 70, as shown in FIG. 2. The jack 70 may have a plurality of holes along an elongate direction of the jack 70. The A-frame 58 may additionally have first and second protruding internally threaded studs 72, 74 (see FIG. 5). The first and second studs 72, 74 may be level with each other such that the jack 70 may be in a horizontal orientation when attached to the first and second studs 72, 74 (see FIG. 2). To attach the jack 70 to the first and second studs 72, 74, the first and second studs 72, 74 are inserted into aligned holes along the elongate direction of the jack 70. Bolts may be attached to the first and second internally threaded studs 72, 74 to secure the jack 70 to the A-frame 58, as shown in FIG. 2.

In use, the tire carrier 10 may be attached to the rear hitch receiver 12. The tire 16 and the jack 70 are mounted to the tire carrier 10. The tire carrier 10 is traversed to the driving position and locked in place with the pin 46, as shown in FIG. 1. While the driver is driving the vehicle 14, the tire of the vehicle 14 may be punctured by sharp objects along the vehicle's path. If the vehicle's tire is punctured, the driver may replace the punctured tire with the spare tire 16. To this end, the spare tire 16 is removed from the flange 54 by loosening the nuts and bolts. With the spare tire 16 removed from the tire carrier 10, the tire carrier 10 is traversed to the access position (see FIG. 2) to remove the jack 70 from the tire carrier 10. In particular, the pin 46 is removed from the apertures of the upper and lower plates 40, 42 and from the through hole of the tubular member 44. Since the pin 46 is tethered to the tire carrier 10 with the cable 48, the pin 46 may be released while the user rotates the first elongate member 22 to the right away from the vehicle 14. With the tire carrier 10 in the access position, the bolts attaching the jack 70 to the A-frame 58 are loosened. The jack 70 is then used to lift the vehicle 14 off of the ground. Once the vehicle 14 is lifted off of the ground, the punctured tire is removed from the axle of the vehicle 14 and mounted to the flange 54. The spare tire 16 is then attached to the axle of the vehicle 14. After the punctured tire is replaced with the spare tire 16, the jack 70 is reattached to the A-frame 58, as shown in FIG. 2. The tire carrier 10 is then traversed back to the driving position by aligning the through hole of the tubular member 44 to the apertures of the upper and lower plates 40, 42. The pin 46 is then inserted therethrough to lock the tire carrier 10 in the driving position.

Also, while driving the vehicle 14, the driver or passengers may need to access the rear of the vehicle 14. To access the rear of the vehicle 14, the driver or passenger removes the pin 46 from the apertures of the upper and lower plates 40, 42 and the through hole of the tubular member 44. The tire carrier 10 is then traversed to the access position (see FIG. 2). In the access position, the first elongate member 22 is rotated away from the vehicle 14. In the access position, the user (e.g., driver or passenger) may now have access to the rear of the vehicle 14. For example, the rear door of the vehicle 14 may be opened to remove or place equipment in the rear of the vehicle 14. After the user has accessed the rear of the vehicle 14, the tire carrier 10 is then traversed back to the driving position by rotating the first elongate member 22 about the pivot axis 18 until the through hole of the tubular member 44 is aligned to the apertures of the upper and lower plates 40, 42. The pin 46 is then inserted through the apertures of the upper and lower plates 40, 42 and the through hole of the tubular member 44.

In an aspect of the tire carrier 10, the same may be traversed to the access position by rotating the first elongate member 22 toward the left instead of the right as discussed above and shown in the figures. Moreover, to this end, the pivot axis 18 will be positioned on the left hand side of the first elongate member forming a rotating joint 32 at the left distal end portions of the first and second elongate members 22, 24. The right distal end portions of the first and second elongate members 22, 24 may have the same structure as discussed above in relation to FIG. 4.

Referring now to FIGS. 1, 2 and 5-8, the tire carrier 10 may be removably attachable to the rear hitch receiver 12 of the vehicle 14. In particular, the tire carrier 10 may additionally comprise a cross bar 76 (see FIG. 5). Distal opposed ends 78a, b of the cross bar 76 may be attached to a lower surface 80 of the second elongate member 24, as shown in FIG. 1. The expandable tongue 20 may be attached to a midpoint of the cross bar 76 as well as an underside of second elongate member 24. The expandable tongue 20 may be traversable between a release position (see FIG. 6) and an expanded position (see FIGS. 7 and 8). In the release position, the expandable tongue 20 may be inserted or removed from the rear hitch receiver 12 of the vehicle 14. In contrast, in the expanded position, the expandable tongue 20, once inserted into the rear hitch receiver 12, does not allow the tire carrier 10 to shake as much as when the expandable tongue 20 is in the release position. The pull out resistance may be provided by a pin 106 (see FIGS. 7 and 8) inserted through an aperture 82 of the rear hitch receiver 12 and an aperture 84 of the expandable tongue 20 (see FIGS. 7 and 8). The expandable tongue 20 when in the expanded position provides vibration resistance or shaking resistance such that the tire carrier 10 does not shake while the vehicle 12 is being driven on uneven terrain.

Referring now to FIGS. 6-8, the expandable tongue 20 may comprise a first part 86 and a second part 88. The first part 86 may have a first camming surface 90 which mates with an opposed second camming surface 92 of the second part 88. The first camming surface 90 may have an inclined orientation. Also, the second camming surface 92 may have an opposing declined orientation. The first camming surface 90 may oppose the second camming surface 92. When the expandable tongue 20 is traversed to the expanded position, the opposed first and second camming surfaces 90, 92 expand the collective outer periphery of the first and second parts 86, 88. The first and second parts 86, 88 may be fabricated from a square or rectangular tube. Accordingly, the first and second camming surfaces 90, 92 may be defined by the lateral sides or edges of the square or rectangular tube. It is also contemplated that steel plates may be welded or attached to the ends of the first and second parts 86, 88. The steel plates may have an aperture through which a drawbolt 98 (discussed below) is inserted. The plates attached to the ends of the first and second parts 86, 88 may define the opposed first and second camming surface 90, 92.

In the release position, the first and second parts 86, 88 are alignable to each other. In contrast, in the expanded position, the first and second parts 86, 88 may be misaligned to each other. To traverse the expandable tongue 20 from the release position to the expanded position, the first part 86 is drawn closer to the second part 88. As the first part 86 is drawn closer to the second part 88, the mating camming surfaces 90, 92 slide upon each other. The first part 86 is forced downward and the second part 88 is forced upward, as shown in FIGS. 7 and 8. The first and second parts 86, 88 move in opposing directions to expand the outer periphery of the collective first and second parts 86, 88. When the expandable tongue 20 is inserted into the rear hitch receiver 12 and traversed to the expanded position, the outer periphery of the collective first and second parts 86, 88 equals the inner periphery of the rear hitch receiver 12, as shown in FIGS. 7 and 8. The first and second parts 86, 88 are further drawn closer to each other to further apply a force against the inner surface of the rear hitch receiver 12. In the expanded position, the expandable tongue 20 provides shaking, vibration and pull out resistance such that the tire carrier 10 does not excessively shake or vibrate while the vehicle 14 is being driven on uneven terrain.

Referring now to FIG. 7, to pull the first part 86 closer to the second part 88, the first part 86 may have a distal collar 94 attached thereto. Similarly, the second part 88 may have a proximal collar 96 attached inside the second part 88. The distal collar 94 may have an aperture with a threaded nut 100 attached to the distal collar 94. The nut 100 may threadingly engage a draw bolt 98. The nut 100 may be welded to the distal collar 94. The draw bolt 98 may have a hex head 102 and may rest on the proximal collar 96. To draw the first part 86 closer to the second part 88, the hex head 102 of the draw bolt 98 is rotated in the clockwise direction such as with a socket wrench. The pin 106 may be removed from apertures 82, 84 at this time. The socket wrench is inserted through a proximal opening 104 (see FIGS. 1 and 7) of the expandable tongue 20. As the draw bolt 98 is rotated in the clockwise direction, the draw bolt 98 further engages the nut 100 and draws the first part 86 closer to the second part 88. The mating camming surfaces 90, 92 slide upon each other to expand or enlarge the collective outer periphery of the first and second parts 86, 88. With the expandable tongue 20 inserted into the rear hitch receiver 12, the expandable tongue 20 is traversed to the expanded position until the collective outer periphery of the first and second parts 86, 88 is equal to an inner periphery of the rear hitch receiver 12. Thereafter, the draw bolt 98 is further rotated in the clockwise direction to apply a force to the inner surface of the rear hitch receiver 12. Such configuration minimizes or mitigates against excessive shaking or vibration when the vehicle 14 is being driven on uneven terrain. To secure the expandable tongue 20 to the rear hitch receiver 12, the pin 106 may be inserted through the apertures 82, 84.

In use, to insert the expandable tongue 20 into the rear hitch receiver 12, the expandable tongue 20 is initially at the release position. The expandable tongue 20 is then inserted into the rear hitch receiver 12 until the apertures 82, 84 are aligned. A socket wrench is inserted through the proximal opening 104 of the second part 88 from a proximal side of the second part 88. The socket wrench engages the hex head 102 of the draw bolt 98 and rotates the draw bolt 98 in a clockwise direction thereby further engaging the nut 100. The first part 86 is drawn closer to the second part 88. Moreover, an outer periphery of the collective first and second parts 86, 88 is enlarged until it equals the inner periphery of the rear hitch receiver 12. The draw bolt 98 is further rotated in the clockwise direction to apply a force against the inner surface of the rear hitch receiver 12 by the expandable tongue 20. The socket wrench is removed from the proximal second part 88. A pin 106 is then inserted into the apertures 82, 84 to provide pull out resistance. The expandable tongue 20 in the expanded position provides shaking or vibration resistance.

In an aspect of the tire carrier 10, the orientation of the draw bolt 98 and the nut 100 may be reversed, as shown in FIG. 8. In particular, the nut 100 may be attached (e.g. welded) to the proximal collar 96. The draw bolt 98 may be inserted through an aperture of the distal collar 94 and threadingly engaged to the nut 100 attached to the proximal collar 96. To install the tire carrier 10 to the rear hitch receiver 12, the expandable tongue 20 is traversed to the release position. The expandable tongue 20 is then inserted into the rear hitch receiver 12 until apertures 82, 84 are aligned. The pin 106 for providing pull out resistance may be inserted through apertures 82, 84. A distal side of the rear hitch receiver 12 allows access to the hex head 102 of the draw bolt 98. A socket wrench is inserted into the distal side of the rear hitch receiver 12, as shown by arrow 108 (see FIG. 8) and engaged to the hex head 102 and rotates the hex head 102 in a clockwise direction. The hex head 102 is rotated in the clockwise direction until the outer periphery of the collective first and second parts 86, 88 is equal to the inner periphery of the rear hitch receiver 12. The hex head 102 is further rotated in the clockwise direction to apply a shaking resistance force to the inner surface of the rear hitch receiver 12. The pin 106 inserted into the apertures 82, 84 of the first and second parts 86, 88 for providing pull out resistance may be inserted into apertures 82, 84 after insertion of the expandable tongue 20 into the rear hitch receiver 12 but before the expandable tongue is traversed to the expanded position or after the expandable tongue 20 is traversed to the expanded position. If the pin 106 is inserted into the apertures 82, 84 before the expandable tongue is traversed to the expanded position, then any movement caused by the traversal of the expandable tongue 20 to the expanded position will not misalign the aperture 82 to the aperture 84.

In an aspect of the tire carrier 10, although the first and second camming surfaces 90, 92 have been shown in the figures as having a generally straight configuration, it is also contemplated that the first and second camming surfaces 90, 92 may have other configurations such as curved, stair stepped, etc. Additionally, it is also contemplated that although the first and second parts 86, 88 are shown and described as expanding vertically, the expandable tongue 20 may be attached to the cross bar 76 such that the first and second parts 86, 88 expand in the horizontal direction. In particular, the expandable tongue 20 may be rotated 90° or 270° about a longitudinal axis of the expandable tongue and attached to the crossbar 76. In this manner, the expandable tongue when traversed to the expanded position, the first and second parts 86, 88 expand horizontally.

In an aspect of the tire carrier 10, the first and second camming surfaces 90, 92 may be oriented 45° with respect to a longitudinal axis of the first and second parts 86, 88. However, it is also contemplated that other angles may be used that are greater than or less than 45° yet achieve the wedging benefits discussed above to reduce shaking or vibration when the vehicle 14 is being driven on uneven terrain.

In an aspect of the tire carrier 10, the first and second parts 86, 88 may be inverted 180° such that the first part 86 contacts an upper surface 110 (see FIGS. 7 and 8) of the receiver. Also, the second part 88 contacts a lower surface 112 (see FIGS. 7 and 8) of the receiver. Accordingly, the second part 88 rests on the lower surface 112 of the receiver to further stabilize the tire carrier 10 while the vehicle 14 is being driven on uneven terrain.

The tire carrier 10 may also have a secondary rear hitch receiver 12a, as shown in FIGS. 1 and 2. The secondary rear hitch receiver 12a may be attached (e.g., welded) atop the second part 88 of the expandable tongue 20 and to a lower surface 120 (see FIG. 2) of the second elongate member 24. The secondary rear hitch receiver 12a may also be disposed below the first and second elongate members 20, 22. The secondary rear hitch receiver 12a may be used to pull a second load or carry an additional attachment in addition to the tire.

More particularly, as shown in FIG. 1, the secondary rear hitch receiver 12a may be disposed between the expandable tongue 20 and the first and second elongate members 22, 24. The secondary hitch receiver 12a may be sized and configured to receive a tongue for carrying other types of loads such as bicycles, equipment, gear, trailer, etc. By way of example and not limitation, the secondary rear hitch receiver 12a may have a square or rectangular configuration. Moreover, the secondary rear hitch receiver 12a may have an aperture 114 (see FIG. 2) sized and configured to receive a pin 116. The pin 116 may be secured in the aperture 114 by retaining clip 118. Accordingly, even though the tire carrier 10 is attached to the rear hitch receiver 12 of the vehicle 14, the vehicle 14 may still tow a second load (e.g., bicycle, gear, equipment, trailer, etc.). As discussed below, the pin 116 secures the second load to the tire carrier 10. Also, the pin 106 secures the tire carrier 10 to the vehicle 14.

As shown in FIG. 7, the expandable tongue 20 is inserted into the rear hitch receiver 12 with the aperture 84 of the expandable tongue 20 aligned to the aperture 82 of the rear hitch receiver. The pin 106, as shown in FIGS. 5 and 7, is inserted into the aligned apertures 82, 84. In this manner, the tire carrier 10, and more particularly, the expandable tongue 20 cannot be pulled out of the rear hitch receiver 12. Accordingly, the tire carrier 10 is tow rated. To ensure that the pin 106 remains disposed within the aligned apertures 82, 84, a retaining clip 118 (see FIG. 5) may be inserted through a hole formed in a first distal end of the pin 106. A second opposed distal end of the pin 106 may be bent or otherwise enlarged, as shown in FIG. 5. Accordingly, the pin 106 is positively disposed within the aligned apertures 82, 84 and cannot be dislodged despite vibrations and other forces urging the pin 106 out of the aligned apertures 82, 84.

A second load may be towed with the tire carrier 10. In particular, the second load may have a tongue (e.g., expandable as discussed above or non-expandable) insertable into the secondary rear hitch receiver 12a. The tongue may have an aperture alignable to the aperture 114 (see FIG. 2) of the secondary rear hitch receiver 12a. The pin 116 may be inserted through the aperture 114 (see FIG. 2) of the secondary rear hitch receiver and the aligned aperture of the tongue carrying the second load. A first distal end of the pin 116 may be bent or otherwise enlarged to prevent the pin 116 from being pushed through the aperture 114. Moreover, a second opposed distal end of the pin 116 may have an aperture sized and configured to receive a retaining clip 118 (see FIG. 2). Once the pin 116 is inserted into the aperture 114, the second distal end of the pin 116 is exposed. The retaining clip 118 is inserted through the aperture formed in the second distal end of the pin 116. The pin 116 is now positively locked or secured in place despite vibration or other forces urging the pin 116 out of the aperture 114 and the aperture formed in the tongue. By the above-described configuration, the tire carrier 10 is able to carry a tire 16 (i.e., first load) and also additionally tow a second load (e.g., bicycle rack, equipment, trailer, etc.). Accordingly, the tire carrier 10 is tow rated for carrying a second load.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A tire carrier for carrying a tire on a rear hitch receiver of a vehicle, the carrier comprising:
a tire mount attachable to the tire;
a frame attached to the tire mount, the frame having an expandable tongue configurable between a release position and an expanded position, the expandable tongue having:
a first part formed with a first camming surface; and
a second part formed with a second camming surface slideably mateable with the first wedge;
wherein the first and second parts collectively have an outer periphery equal to an inner periphery of the rear hitch receiver at the expanded position to reduce shaking of the tire carrier while the vehicle is in motion, the outer periphery of the first and second parts is collectively smaller than the inner periphery of the rear hitch receiver at the release position to allow removal of the tire carrier from the rear hitch receiver of the vehicle.

2. The tire carrier of claim 1 wherein the outer periphery of the first and second parts have a rectangular cross sectional configuration and the inner periphery of the rear hitch receiver has a matching rectangular configuration.

3. The tire carrier of claim 1 wherein the first part comprises a plate attached to a hollow center of the first part, the plate having a through hole sized and configured to receive a draw bolt, and the second part comprises a threaded through hole for receiving a threaded distal end portion of the draw bolt.

4. The tire carrier of claim 1 wherein the first and second camming surfaces have an inverted configuration with respect to each other.

5. The tire carrier of claim 1 wherein the first and second camming surfaces are skewed with respect to a longitudinal axis of the expandable tongue.

6. The tire carrier of claim 5 wherein the first and second camming surfaces are skewed at a 45° angle with respect to the longitudinal axis of the expandable tongue.

7. A tire carrier for carrying a tire at a rear of a vehicle, the vehicle defining opposed first and second sides, the carrier comprising:
a frame attached to the vehicle, the frame having:
a first elongate member having a length about equal to a width of the vehicle, the first elongate member being rotatable away from the vehicle about a pivot axis to an access position for providing access to the rear of the vehicle, the pivot axis disposed adjacent the first side of the vehicle;
a tire mount attachable to the tire and attached to the first elongate member, the tire mount disposed adjacent the second side for allowing clearance between the tire mounted to the tire mount and the vehicle when the first elongate member is at the access position.

8. The tire carrier of claim 7 wherein the frame further comprises a second elongate member having a length about equal to the width of the vehicle, the second elongate member being stationary with respect to the vehicle, the first elongate member being rotatable with respect to the second elongate member.

9. The tire carrier of claim 7 wherein the first elongate member rotates to a left side or a right side of the vehicle.

10. The tire carrier of claim 7 wherein a center of gravity of a tire mounted to the tire carrier is offset from a midpoint of the vehicle.

11. The tire carrier of claim 10 wherein the center of gravity of the tire mounted to the tire carrier is on opposing sides of the vehicle midpoint with respect to the pivot axis.

12. The tire carrier of claim 7 wherein the frame further comprises an upright plate attached to both the first elongate member and the tire mount.

13. The tire carrier of claim 7 wherein the tire mount is a tire flange.

14. A tire carrier for carrying a tire and towing a load with a rear hitch receiver of a vehicle, the tire carrier comprising:
a frame attachable to the vehicle, the frame having:
a first elongate member being rotatable away from the vehicle about a pivot axis to an access position for providing access to the rear of the vehicle;
a tire mount attachable to the tire and attached to the first elongate member;
a tongue attached to the first elongate member receivable into the rear hitch receiver of the vehicle for attaching the frame to the vehicle;
a secondary rear hitch receiver attached to the tongue for towing the load with the tire carrier.

15. The tire carrier of claim 14 wherein the secondary rear hitch receiver is attached atop the tongue.

16. The tire carrier of claim 14 wherein the secondary rear hitch receiver is attached to and disposed between the tongue and a second elongate member which is rotateably attached to the first elongate member.
